(19) United States
(12) Patent Application Publication
(10) Pub. No.: US 2024/0317496 A1
(43) Pub. Date: Sep. 26, 2024

(54) STORAGE AND RETRIEVAL UNIT FOR A HIGH-BAY WAREHOUSE

(71) Applicant: AMOVA GmbH, Hilchenbach (DE)

(72) Inventors: Bernd KLEIN, Hilchenbach (DE); Bernd BÜDENBENDER, Siegen (DE)

(73) Assignee: AMOVA GmbH, Hilchenbach (DE)

(21) Appl. No.: 18/578,817

(22) PCT Filed: Jul. 5, 2022
(86) PCT No.: PCT/EP2022/068501

§ 371 Date: Jan. 12, 2024

(30) Foreign Application Priority Data
Jul. 12, 2021 (DE) 10 2021 117 938.6

(51) Int. Cl. B65G 1/04

(52) U.S. Cl. CPC B65G 1/0492

(57) ABSTRACT

The invention relates to a storage and retrieval unit 1 for a high-bay warehouse 2. Due to the pivotability and vertical movability of the load accepting means 14 in relation to the frame 11 of the storage and retrieval unit 1 outside the guide 13 of the load accepting means 14, a misalignment of a storage item 3 during a transfer process can be compensated for.

### CROSS-REFERENCE TO RELATED APPLICATION

This application is a national stage application, filed under 35 U.S.C. § 371, of International Patent Application PCT/EP2022/068501, filed on Jul. 5, 2022, which claims the benefit of German Patent Application DE 10 2021 117 938.6, filed on Jul. 12, 2021.

### TECHNICAL FIELD

The disclosure relates to a storage and retrieval unit for a high-bay warehouse.

### BACKGROUND

A high-bay warehouse usually consists of any number of shelves arranged side by side, wherein a single bay has a plurality of adjacent shelves along its length and height. Storage and retrieval units, in particular automated storage and retrieval units, are known from the prior art for the storage or retrieval, as the case may be, of a storage item in a shelf and the transport of the storage item in the high-bay warehouse. At defined transfer points, such storage and retrieval units can exchange the storage items with external vehicles. Here, external vehicles are, for example, trucks, autonomously driving vehicles or rail-bound vehicles.

An external vehicle with the storage item heads for a predefined position for the exchange. The storage and retrieval unit takes up a suitable position within the high-bay warehouse, in particular in a storage aisle, and establishes a connection with the storage item. This is typically effected at three or more fastening points of a load accepting means with the complementary fastening points of the storage item. The storage item is then moved to its position in the high bay and stored there.

A storage and retrieval unit for a high-bay warehouse is known from WO 2017/158 034 A1, for example. Such storage and retrieval unit is suitable for transporting and transferring one storage item within a high-bay warehouse. Furthermore, such storage and retrieval unit can also exchange storage items with external vehicles. The storage and retrieval unit has a base frame that can move within a storage aisle of the high bay. A load accepting means is connected to this frame, which device can be moved in a horizontal plane to store or retrieve, as the case may be, the storage item from the shelf. Furthermore, in order to transfer the storage item to an external vehicle, the load accepting means can be lowered in the vertical direction. These two movements are each enabled by a telescopic structure that establishes the connection between the frame and the load accepting means. Thereby, the load accepting means has fastening points for connection to the storage item, whereby such fastening points span a fastening plane.

A disadvantage of such storage and retrieval unit is that it is not able to compensate for misalignments between the fastening points of the load accepting means and those of the storage item that result from a rotation of the fastening plane about one of the three main axes. This can occur if, for example, the storage area of a truck is not parallel to the storage level of the high-bay warehouse or the truck is positioned at an angle in the aisle between the high-bay warehouses. Then, a connection of the load accepting means with the storage item is no longer possible if a tolerance is exceeded.

### SUMMARY

It is an object of the disclosure to provide a storage and retrieval unit that is able to better compensate for misalignments of the fastening points, in particular those resulting from a rotation, than known units.

The object is achieved by a storage and retrieval unit as disclosed herein, by a system comprising a storage and retrieval unit and a high-bay as disclosed herein, by a system comprising a storage and retrieval unit and a storage item as disclosed herein and by a method for picking up or depositing a storage item as disclosed herein.

The storage and retrieval unit has a frame and a load accepting means with at least three fastening points, wherein the load accepting means is movable in relation to the frame. The movement of the load accepting means is guided by a guide connected to the frame. The load accepting means can be moved vertically in relation to the frame of the storage and retrieval unit outside its guide and can be pivoted, in particular about axes in a horizontal plane. This enables the storage and retrieval unit to compensate for both rotation of the fastening points within the storage plane and rotation of the fastening points about an axis within the storage plane. This allows the storage and retrieval unit to compensate for larger misalignments of the fastening points compared to the prior art.

The fastening points of the load accepting means of the storage and retrieval unit are preferably suitable for connecting the load accepting means to a container, in particular a sea container, as a load. The advantage here is that containers are standardized storage items with standardized positions of the fastening points. Onshore transportation is mostly by truck, with which there are often misalignments with respect to the transfer location. Here, the storage and retrieval unit according to the invention can compensate for the misalignments particularly well.

The vertical travel distance of the load accepting means guided by the guide connected to frame of the storage and retrieval unit is preferably smaller than the maximum vertical travel distance of the load accepting means when exchanging a load with an external vehicle. The smaller the guided travel distance of the load accepting means, the more misalignments can be compensated for.

The force-transmitting length of the connecting element between the load accepting means and the frame of the storage and retrieval unit can preferably be changed. As a result, the transport of the storage item can take place in a rigid frame and the necessary flexibility to compensate for misalignments is provided outside the frame.

The load accepting means and/or the frame of the storage and retrieval unit preferably has an assembly that enables a rotation of the load accepting means in the horizontal plane. This makes it possible to compensate for a misalignment of the fastening points independently of the connecting element.

The frame of the storage and retrieval unit is preferably connected to the load accepting means by a cable, chain and/or toothed belt as a connecting element, preferably more than two cables, chains and/or toothed belts. The length of the cable, chain and/or toothed belt is preferably variable by means of a drum driven by a motor. Such connecting elements are readily available and the design of corresponding motors, gearboxes, controls and drums can be derived from other applications.

Two or more cables, chains and/or toothed belts preferably connect the load accepting means to the frame of the storage and retrieval unit and the length of the at least one cable, chain and/or toothed belt can be adjusted independently of the length of a second cable, chain and/or toothed belt. By using a different length control, a rotation around one axis can be easily realized for two connecting elements. Provided that three or more connecting elements can be adjusted independently of one another, rotations about more than one axis can also be realized.

The frame of the storage and retrieval unit preferably has at least one drum for adjusting the length of the cable, chain and/or toothed belt. The attachment of the drum to the frame has the advantage that the forces that arise can be better transmitted to the frame.

At least one connecting element is preferably designed as a cylinder, preferably as a hydraulic cylinder. Cylinders, in particular hydraulic cylinders, can transmit large loads and be controlled very precisely. This allows a position offset to be compensated for with a high degree of precision.

More than two cylinders preferably connect the frame to the load accepting means. The use of two cylinders increases safety in the event of failure.

The length of the at least one cylinder is preferably adjustable independently of the length of another cylinder. Two independently controllable cylinders enable a rotation of the plane of the fastening points about an axis. If three or more cylinders are used, rotations about more than one axis are also possible.

Preferably, the load accepting means has a frame and the frame of the load accepting means has more than three fastening points for a storage item, preferably a container. The fastening points are preferably movable in relation to the frame of the load accepting means. The frame gives strength to the load accepting means and thus facilitates positioning in relation to the storage item. The mobility of the fastening points also enables adaptation to different distances between the fastening points within the fastening plane or adaptation to a necessary alignment in relation to the fastening points of the storage item.

The frame of the load accepting means can preferably be connected to the frame of the storage and retrieval unit in a positive-locking or form-fitting manner. This makes it easier to transport a storage item by the storage and retrieval unit during transport within the high-bay warehouse.

The frame of the storage and retrieval unit preferably has a receptacle complementary to the frame of the load accepting means for establishing a positive-locking fit between the two frames. A locking mechanism, preferably with movable pins, makes it difficult, preferably impossible, to release the positive-locking fit between the two frames. This design further increases safety when transporting the storage item in the high-bay warehouse.

A system comprises a storage and retrieval unit and a high-bay warehouse. It is possible by means of the storage and retrieval unit to transfer storage items, in particular containers, between a storage location in a high-bay warehouse and a vehicle or another storage location the high-bay warehouse. The storage and retrieval unit is designed as described above.

A further system includes a storage and retrieval unit as described above and a storage item, in particular a container, preferably a sea container. The storage item has fastening points complementary to the fastening points on the load accepting means of the storage and retrieval unit, and the storage item can be releasably connected to the load accepting means by means of the complementary fastening points. This allows different storage items to be handled rapidly even if there are misalignments between the respective fastening points that belong together.

A method can be used for picking up or depositing a storage item, in particular a container. The storage item is picked up or deposited by a vehicle, preferably by means of a storage and retrieval unit designed as described above. At least one fastening point of the storage item deviates from the horizontal and/or vertical target position at which the following work steps are carried out:
a) Moving the storage and retrieval unit to the target position;
b) Lowering the load accepting means to a first deposit or pick-up height;
c) Lowering and/or rotating the load accepting means to a second deposit or pick-up height at which at least one fastening point does not transmit a vertical force;
d) Lowering and/or rotating the load accepting means to a third deposit or pick-up height of the load accepting means at which the other fastening points do not transmit any vertical force;
e) Releasing or connecting the fastening points from or to the storage item.

It is preferred if the work steps are carried out in the sequence a) to e), wherein preferably the work steps a) and b) and/or c) and d) can also take place at least partially simultaneously.

### BRIEF DESCRIPTION OF THE DRAWINGS

FIG. 1: High-bay warehouse with a storage and retrieval unit and external vehicle.

FIG. 2: Planes of fastening points of the storage item and the load accepting means with misalignment.

FIG. 3a): Storage and retrieval unit with load accepting means in vertical deflection.

FIG. 3b): Storage and retrieval unit in the transport state with a closed lock.

FIG. 3c): Storage and retrieval unit during transfer of the storage item to the vehicle.

FIG. 4: Load accepting means with a movable fastening point

### DETAILED DESCRIPTION

The invention is described in detail below with reference to the specified figures in the form of exemplary embodiments. In all figures, the same technical elements are provided with the same reference signs.

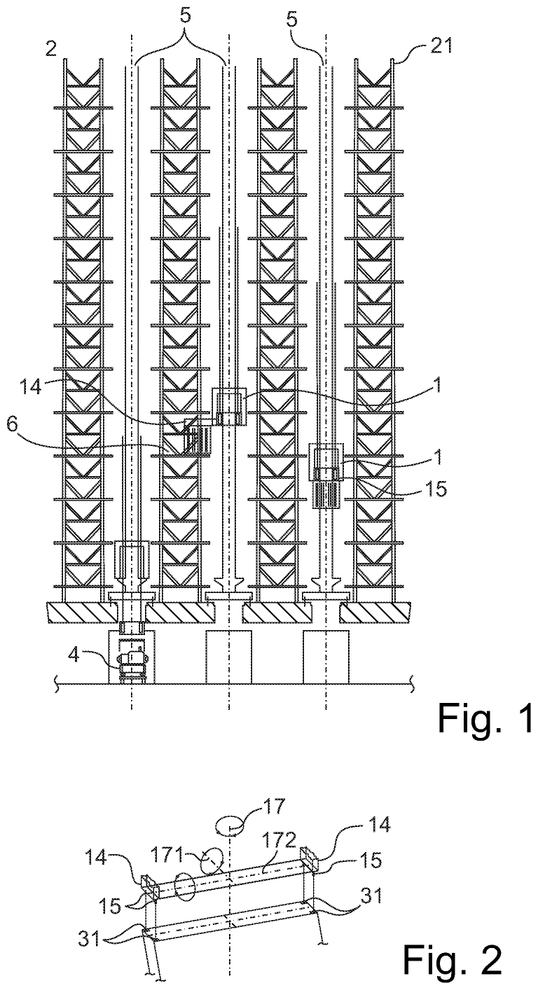

FIG. 1 shows a schematic representation of a high-bay warehouse 2 with a storage and retrieval unit 1. The storage and retrieval unit 1 can move within the aisle 5 between two high bays 21. The external vehicle 4, for example a truck, is located below the aisle 5 between the two high bays 21. The storage and retrieval unit 1 can remove a sea container from its storage location 6 by a largely horizontal movement and place it on the vehicle 4, in this case a truck, by a largely vertical movement. During this entire operation, the sea container is connected to the load accepting means 14 of the storage and retrieval unit 1 at four fastening points 15.

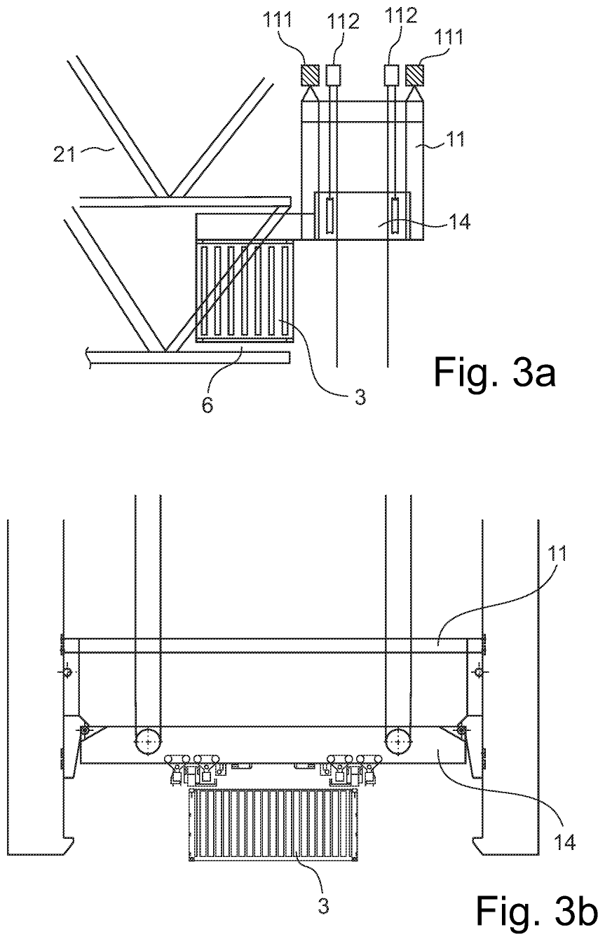

FIG. 2 shows the fastening points 15 of the load accepting means 14 and the fastening points 31 of the storage item 3. Such points span a respective plane. Such two planes must be aligned parallel and congruent to one another by the rotations indicated by the arrows for a connection of the fastening points (15, 31). The distance between the fastening points 15 of the load accepting means 14 can be adapted to match the distance between the fastening points 31 of the storage item 14. The fastening points 15 of the load accepting means are also rotatably mounted so that they can compensate for angular misalignment.

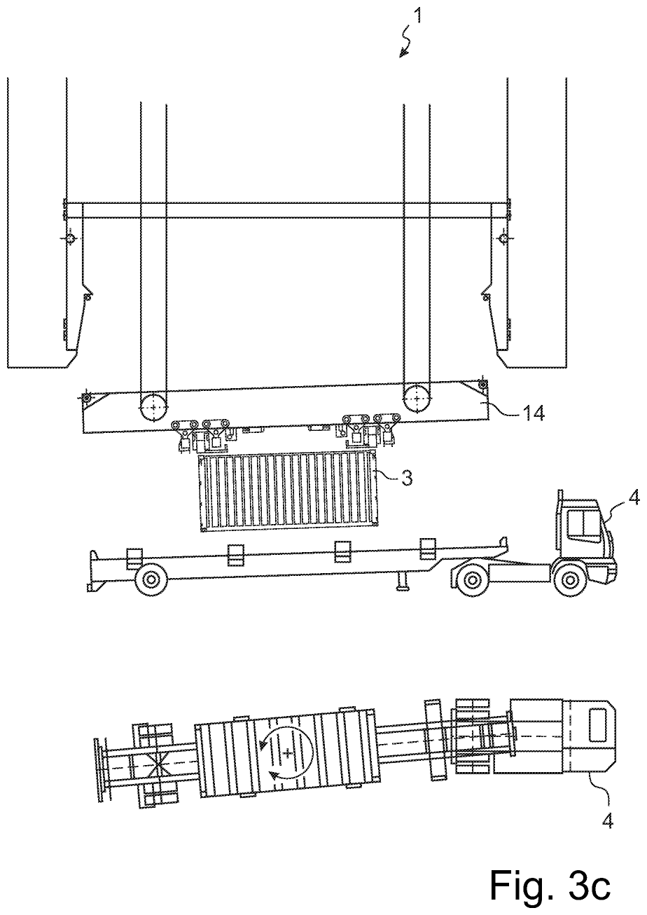

FIGS. 3 a) to c) show exemplary different positions of the load accepting means 14 in relation to the frame 11 of the storage and retrieval unit 1. The load accepting means 14 is connected to the frame 11 of the storage and retrieval unit 1 by four independently controllable cables. The length of the cables can be changed by the cable drums 112 controlled by motor 111 or gearbox, as the case may be. FIG. 3 a) shows the horizontal deflection during the storage or retrieval, as the case may be, of a storage item 3 from the storage location 6 in the high bay 21.

In FIG. 3 b), the storage item 3 is in the transport position with the load accepting means 14. Four locking pins secure the load accepting means 14 against the release from the frame 11 of the storage and retrieval unit 1. The locking pins can be moved by a respective actuator, for example a hydraulic cylinder.

FIG. 3 c) shows the storage and retrieval unit 1 with the storage item 3 shortly before it is placed on the vehicle 4. To compensate for a misalignment, the load accepting means 14 with the storage item 3 connected to it is rotated about two axes. The loading surface of the truck 4 is inclined in relation to the horizontal and rotated about an axis perpendicular to the loading surface.

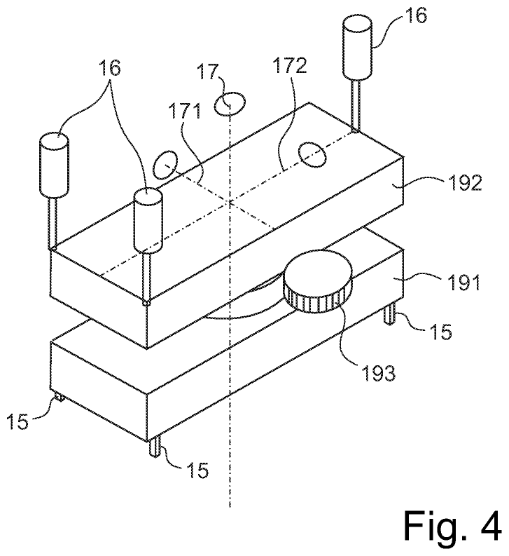

FIG. 4) shows a load accepting means 14 with four movable fastening points 15 and a rotation option. The fastening points 15 are each rotatably mounted on a first frame 191 along two axes, i.e., each individual fastening point can move independently of the other fastening points from the vertical position in relation to the first frame. The first frame 191 is connected to an overlying second frame 192 rotatably about a vertical axis. The rotation of the two frames 191, 192 relative to one another is effected, for example, by a drive with a gear wheel 193 or a gearbox. The second frame 192 is then connected to the frame 11 of the storage and retrieval unit 1 by means of the connecting elements 16, in this case three hydraulic cylinders.

### DESIGNATIONS IN FIGURES

Number Description
1 Storage and retrieval unit
11 Frame
111 Motor
112 Drum
14 Load accepting means
15 Fastening point
16 Connecting elements
17 Axis of rotation
171 Horizontal axis
172 Horizontal axis
191 Frame
192 Frame
193 Gear wheel
2 High-bay warehouse
21 High bay
3 Storage item
31 Fastening point on the storage item
4 Vehicle
5 Aisle
6 Storage location

1.-18. (canceled)

19. A storage and retrieval unit (1) for a high-bay warehouse (2), comprising:
a frame (11) with at least one drive for moving the storage and retrieval unit (1) along a high-bay (21);
a load accepting means (14) having at least three interconnected fastening points (15) for releasably fastening a storage item (3) to the load accepting means (14);
a connecting element (16) that connects the frame (11) to the load accepting means (14) for transmitting forces from the storage item (3) via the load accepting means (14) to the frame (11); and
a vertical guide (13) for the load accepting means (14), the vertical guide (13) being connected to the frame (11) and configured to guide the load accepting means (14) in a lower half of the frame (11) and/or below the frame (11); and
wherein the storage item (3) is exchangeable with a storage location (6) in the high bay (21) by a substantially horizontal movement of the storage item (3) by the storage and retrieval unit (1), and the storage item (3) is exchangeable with a vehicle (4) by a substantially vertical movement, and
wherein the load accepting means (14) is vertically movable in relation to the frame (11) within the guide (13), and
wherein the load accepting means (14) can be moved vertically in relation to the frame (11) outside the guide (13) and can be pivoted about axes (171, 172) in a horizontal plane (18).

20. The storage and retrieval unit (1) according to claim 19,
wherein the storage item (3) is a container, and
wherein the fastening points (15) are suitable for connecting the load accepting means (14) to the container.

21. The storage and retrieval unit (1) according to claim 19,
wherein a vertical travel distance (19) of the load accepting means (14) guided by the guide (13) connected to the frame (11) is smaller than a maximum vertical travel distance of the load accepting means when exchanging the storage item (3) with the vehicle (4).

22. The storage and retrieval unit (1) according to claim 19,
wherein a force-transmitting length of the connecting element (16) between the load accepting means (14) and the frame (11) can be changed.

23. The storage and retrieval unit (1) according to claim 19,
wherein the load accepting means (14) and/or the frame (11) has an assembly with which the load accepting means (14) can be rotated in the horizontal plane.

24. The storage and retrieval unit (1) according to claim 19,
wherein the connecting element (16) comprises a cable, a chain and/or a toothed belt, and
wherein a length of the cable, the chain and/or the toothed belt is variable by means of a drum (112) driven by a motor (111).

25. The storage and retrieval unit (1) according to claim 19,
wherein the connecting element (16) comprises two or more cables, chains and/or toothed belts connecting the load accepting means (14) to the frame (11), and
wherein a length of one of the two or more cables, chains and/or toothed belts is adjustable independently of a length of another one of the two or more cables, chains and/or toothed belts.

26. The storage and retrieval unit (1) according to claim 24,
wherein the frame (11) has at least one drum (112) for adjusting the length of the cable, the chain and/or the toothed belt.

27. The storage and retrieval unit (1) according to claim 19,
wherein the connecting element (16) comprises a cylinder.

28. The storage and retrieval unit (1) according to claim 27,
wherein more than two cylinders connect the frame (11) to the load accepting means (14).

29. The storage and retrieval unit (1) according to claim 28,
wherein a length of one of the more than two cylinders is adjustable independently of a length of another one of the more than two cylinders.

30. The storage and retrieval unit (1) according to claim 19,
wherein the load accepting means (14) has a further frame (19), and
wherein the further frame (19) of the load accepting means has more than three fastening points (15) for the storage item, and
wherein the more than three fastening points (15) are movable in relation to the further frame (19) of the load accepting means (14).

31. The storage and retrieval unit (1) according to claim 30,
wherein the further frame (19) of the load accepting means (14) can be connected to the frame (11) of the storage and retrieval unit (1) in a positive-locking or force-fitting manner.

32. The storage and retrieval unit (1) according to claim 30,
wherein the frame (11) of the storage and retrieval unit (1) has a receptacle complementary to the further frame (19) of the load accepting means (14) for establishing a positive-locking fit between the frame (11) and the further frame (19), and
wherein a locking mechanism with movable pins makes it impossible to release the positive-locking fit between the frame (11) and the further frame (19).

33. A system, comprising:
the storage and retrieval unit (1) according to claim 19; and
the high-bay warehouse (2),
wherein it is possible by means of the storage and retrieval unit (1) to transfer storage items (3) between a storage location (6) in the high-bay warehouse (21) and a vehicle (4) or another storage location (6) in the high-bay warehouse (21).

34. A system, comprising:
the storage and retrieval unit (1) according to claim 19; and
the storage item (3),
wherein the storage item (3) has complementary fastening points (15) that are complementary to the at least three interconnected fastening points (15) on the load accepting means (14), and
wherein the storage item (3) can be releasably connected to the load accepting means (14) by means of the complementary fastening points.

35. A method for picking up or depositing a storage item (3),
wherein the storage item (3) is picked up from or deposited on a vehicle (4), and
wherein at least one fastening point of the storage item (3) deviates from a horizontal and/or vertical target position,
the method comprising:
a) moving a storage and retrieval unit (1) to a target position;
b) lowering a load accepting means (14) to a first deposit or pick-up height;
c) lowering and/or rotating the load accepting means (14) to a second deposit or pick-up height at which at least one fastening point (15) does not transmit any vertical force;
d) lowering and/or rotating the load accepting means (14) to a third deposit or pick-up height of the load accepting means (14) at which further fastening points (15) do not transmit any vertical force; and
e) releasing the fastening points (15) from the storage item (3) or connecting the fastening points (15) to the storage item (3).

36. The method according to claim 35,
wherein the steps are carried out in the order a) to e).
